(19) United States
(12) Patent Application Publication
(10) Pub. No.: US 2025/0029392 A1
(43) Pub. Date: Jan. 23, 2025

(54) REAL-TIME TRAFFIC ASSISTANCE AND DETECTION SYSTEM AND METHOD

(71) Applicant: Black Sesame Technologies Inc., San Jose, CA (US)

(72) Inventors: Zhenhui Jiang, Cupertino, CA (US); Zuoguan Wang, Los Gatos, CA (US); Qun Gu, San Jose, CA (US)

(21) Appl. No.: 18/224,046

(22) Filed: Jul. 19, 2023

(51) Int. Cl. G06V 20/58; G06T 3/40; G06T 7/73; G06V 10/26; G06V 10/764; G06V 10/82

(52) U.S. Cl. CPC G06V 20/58; G06T 3/40; G06T 7/73; G06V 10/26; G06V 10/764; G06V 10/82; G06T 2207/20084; G06T 2207/20132; G06T 2207/30236; G06T 2207/30261

(57) ABSTRACT

The present invention discloses a system and a method for real-time image based traffic detection for self-driving and advanced driver-assistance systems (ADAS). The system and method include conversion of a resized image by an image reducer with resolution smaller than the image generated. The resized image is used for further analysis and uses less computing resources to provide real-time traffic assistance to the vehicle.

### FIELD OF THE INVENTION

The present invention relates to systems and methods for real-time traffic assistance and detection. More particularly, the invention relates to image based traffic detection for self-driving and advanced driver-assistance systems (ADAS).

### BACKGROUND OF THE INVENTION

Neural networks are used in a plurality of applications, especially since the development of convolutional neural networks. These neural network based approaches have been widely used for image and natural language identification. Neural networks extract features from data sets, such as images, to recognize patterns in the data. Such approaches are particularly useful for traffic detection.

Traffic signs are an important component of any road traffic system. Traffic signs include traffic lights, information regarding current road segments, prompts regarding dangers or hazards in driving environment, and similar driver warnings. Accurate and timely detection and inference of traffic lights and signs is crucial for driving safety and comfort.

Traffic sign recognition generally comprises two key steps: detection and identification. Various traffic sign recognition approaches for traffic assistance to vehicles have been employed in recent years. Some of the convolutional network based approaches are highlighted in the prior art regarding traffic detection for self-driving and advanced driver-assistance systems (ADAS).

A 2012 research paper entitled “Real-Time Traffic-Sign Recognition Using Tree Classifiers” by Zaklouta et al. introduced a smart approach using machine learning models to recognize traffic signs. The inventor evaluated the performance of k-d trees, random forests, and support vector machines (SVMs) for traffic-sign classification. The performance is evaluated using different-sized histogram-of-oriented-gradient (HOG) descriptors and distance transforms (DTs). Robust classification of faulty samples detected traffic signs that are traditionally omitted by other systems is done, e.g. over-illumination, under-illumination, rotation, occlusion, and deterioration of the sign. This method however focuses only on Classification aspect for ADAS.

A 2008 research paper entitled “Detection, tracking and recognition of traffic signs from video input” by Ruta et al. explores the possibility of the usage of color contrast that is used by human eyes to distinguish between a road/traffic sign and the environment. Using classic computer vision techniques and input from an on-board device, the system detects the traffic signs on the road. However, recognition based on solely color contract is prone to false or no detection in cases of conditions where color is not that prominent due to poor weather conditions, inadequate daylight etc.

A 2018 research paper entitled, “Evaluation of Deep Neural Networks for traffic sign detection systems” by Arcos-Garcia et al. considers several convolutional neural network (CNN) object-detection systems combined with various feature extractions protocols. The single step method is used for detection and classification of the traffic signs directly. Simple detection of any traffic sign is not enough due to a lot of sub-categories or exclusive meanings and context of the individual traffic signs encountered. Hence, it is an extremely heavy and complex task for an object detector to include all of them, which also brings many more floating point operators (FLOPs). The cited paper groups the signs in four categories, namely: mandatory, prohibitory, danger, and other. The paper groups between super-categories and not between specific classes (e.g., a 70 or 80 km/h traffic sigh has the same class label). Therefore, that system is neither adequate nor precise.

A 2017 research paper entitled “Efficient Traffic-Sign Recognition with Scale-aware CNN” by Yang et al. presents a traffic sign recognition (TSR) system which can rapidly and accurately recognize traffic signs of different sizes in images. The system uses two designed CNN for region and classification of signage. In addition, a modified “Online Hard Example Mining” (OHEM) scheme is adopted to avoid false detections. Moreover, a lightweight classification sub-network with multi-scale feature fusion structure and “Inception” module is presented and validated. The use of specific and complex models in this system makes it impractical for typical object detectors and classification schemes.

It is still a challenge to recognize traffic signs and traffic lights in self-driving and advanced driver-assistance systems (ADAS) as computer and memory are limited on edge devices, which limits the choice of approach for the object detection. Some approaches require higher processing or complex models for learning. Alternatively, the input size of images is also limited due to constraints on computing resources.

The proposed framework of the present invention is simple and easy to use with all kinds of object detectors and classifications of traffic information. In the present invention, a novel two-stage detection and recognition approach for traffic signs and traffic lights is disclosed. Therefore, the present invention is designed to address the peculiar challenges in the prior arts.

It is apparent now that numerous methods and systems are developed in the prior art that are adequate for various purposes. Furthermore, even though these inventions may be suitable for the specific purposes to which they address, accordingly, they would not be suitable for the purposes of the present invention as heretofore described. Thus, there is a need to provide a novel two-stage detection and recognition approach for traffic signs and traffic lights.

### SUMMARY OF THE INVENTION

In accordance with the present invention, the disadvantages and limitations of the prior art are substantially avoided by providing a novel two-stage detection and recognition system and method for traffic signs and traffic lights detection.

The system according to the present invention uses a novel two-stage approach for real-time traffic sign recognition (TSR) and traffic light recognition (TLR) on edge devices. According to a preferred embodiment of the present invention, an image capturing module is associated with on-board instruments of a vehicle. The image capturing module is any device capable of generating an image in real time during operation of the vehicle, for example a camera or video onboard system.

Typically the image is captured by the image capturing module is large in size, i.e., 1080p or above. According to a preferred embodiment of the present invention, the image consists of one or more objects detected by the image capturing module. The one or more objects are traffic/lights/signs indicating traffic/road related information. The first stage of a system for providing real-time traffic assistance to a vehicle of the present invention is using the image as input to a processing module.

According to preferred embodiment of the present invention, the processing module includes a cropping module and an image classifier. The cropping module finds the one or more objects within the image and cuts them out of the image to generate a one or more cropped image. The filtering module filters the one or more cropped image on the basis of orientation of traffic light/signs. According to a preferred embodiment, each one of the one or more cropped images are analyzed and only those facing toward the image capturing module are chosen by the filtering module to generate one or more filtered images.

In the second stage of a system for providing real-time traffic assistance to a vehicle of the present invention, the one or more filtered images are then fed into the image classifier of the processing module to classify the one or more filtered images on the basis of traffic/road classification. According to a preferred embodiment, an image classifier is used by the processing module to classify the one or more objects on the basis of standard classification codes for traffic/road safety. These classification codes are related to more specific details regarding each one of the one or more objects. For example, if one of the one or more objects is a speed limit sign, then the image classifier will further classify the sign based on actual speed limit in real time, e.g., speed limit 60 mph. The image classifier uses various neural network based approaches to correctly associate traffic sign classification to the one or more filtered images.

In the primary objective of the present invention, the image is converted into a resized image by an image reducer with resolution smaller than the image generated by the image capturing module on-board. The image reducer converts the image from image capturing module to a resized image. The resized image is used for further analysis and uses less computing resources.

In another objective of the present invention, the traffic analysis module merges the one or more filtered images from the image classifier to the resized image. The image capturing module provides real time assistance to the vehicle by further comparing the classification and location within the resized images. Therefore, the traffic analysis module can accurately detect traffic signs and information in real time.

Further aspects of the invention will become apparent from the following detailed description, taken in conjunction with the accompanying drawings, which illustrate, by way for example, the features in accordance with embodiments of the invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

Although, the invention is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

### BRIEF DESCRIPTION OF THE DRAWINGS

The accompanying drawings illustrate various embodiments of systems and methods in accordance with the present invention. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice-versa. Furthermore, elements may not be drawn to scale. Non-limiting and non-exhaustive descriptions are described with reference to the following drawings. The components in the figures are not necessarily to scale, with emphasis instead being placed upon illustrative principles.

Embodiments of the invention are described with reference to the following figures. The same numbers are used throughout the figures to reference like features and components. The features depicted in the figures are not necessarily shown to scale. Certain features of the embodiments may be shown exaggerated in scale or in somewhat schematic form, and some details of elements may not be shown in the interest of clarity and conciseness.

FIG. 1 illustrates a system for providing real-time traffic assistance to a vehicle in accordance with the present invention;

FIG. 2 illustrates a mode of providing real-time traffic assistance using an image captured by on-board image capturing device of a vehicle in accordance with the present invention; and

FIG. 3 illustrates a method of providing real-time traffic assistance to a vehicle in accordance with the present invention.

### DETAILED DESCRIPTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention.

Also, the terminology and phraseology used is for the purpose of describing exemplary embodiments and should not be considered limiting. Thus, the present invention is to be accorded the widest scope encompassing numerous alternatives, modifications, and equivalents consistent with the principles and features disclosed. For purpose of clarity, details relating to technical material that are known in the technical fields related to the invention have not been described in detail so as not to unnecessarily obscure the present invention.

In the description and claims of the application, each of the words “units” represents the dimension in any units such as centimeters, meters, inches, foots, millimeters, micrometer and the like and forms thereof, are not necessarily limited to members in a list with which the words may be associated.

In the description and claims of the application, each of the words “comprise”, “include”, “have”, “contain”, and forms thereof, are not necessarily limited to members in a list with which the words may be associated. Thus, they are intended to be equivalent in meaning and be open-ended in that an item or items following any one of these words is not meant to be an exhaustive listing of such item or items, or meant to be limited to only the listed item or items. It should be noted herein that any feature or component described in association with a specific embodiment may be used and implemented with any other embodiment unless clearly indicated otherwise.

The presence of broadening words and phrases such as “one or more,” “at least,” “but not limited to” or other like phrases in some instances shall not be read to mean that the narrower case is intended or required in instances where such broadening phrases may be absent.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred, systems and methods are now described.

The present invention is related to image processing systems and methods that are applied within vehicular systems, so as to provide assistance to self-driving systems of a vehicle for safe and efficient driving.

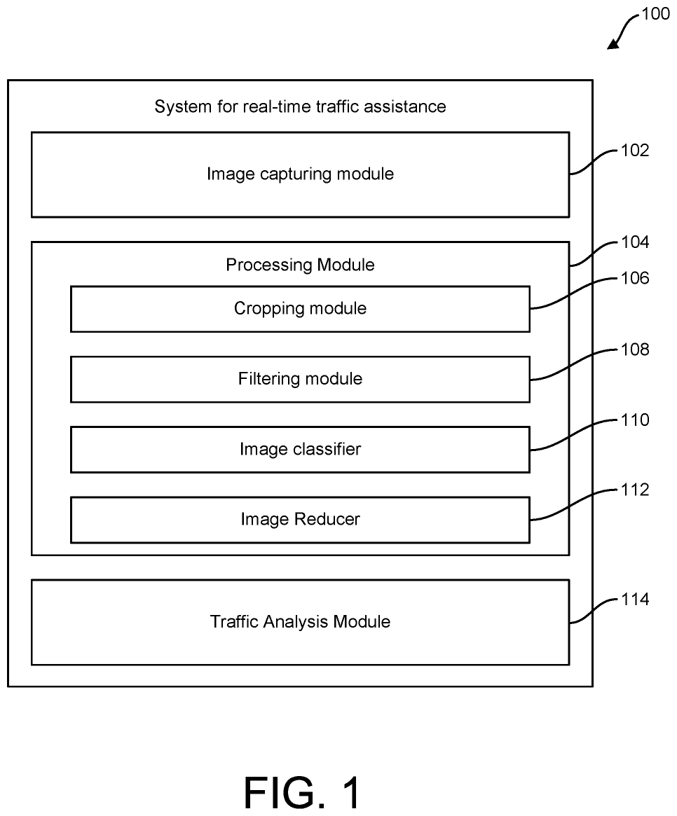

FIG. 1 illustrates a system for providing real-time traffic assistance to a vehicle, including an advanced driver-assistance system (ADAS) for manual driving. The system 100 is for providing real-time traffic assistance according to an embodiment of the present invention. The system 100 includes an image capturing module 102, a processing module 104, and a traffic analysis module 114. The system 100 involves two stages of handling an image that is generated by the image capturing module.

The first stage involves cropping and classifying the image, followed by resizing and analysis. The image capturing module 102 is any device capable of generating images of real time view of road/traffic around the vehicle. According to a preferred embodiment of the present invention, the image capturing module 102 is a camera. The image capturing module 102 can also be a dash-cam or a video recording device present onboard the vehicle. Individual frames of video generated by the video capturing device can be used as the image for further processing. The image generated from image capturing module 102 is a real time view of the road or drive-way for any vehicle. According to a preferred embodiment of the present invention, the image includes one or more objects. Aside from the road, the one or more objects captured within the image includes traffic signs, traffic lights, road safety, and/or any driving related information.

The image is used as input for a processing module 104 of the system 100. According to a preferred embodiment of the present invention, the processing module 104 includes a cropping module 106, a filtering module 108, an image classifier 110, and an image reducer 112. The processing module 104 is responsible for taking the image from the image capturing module 102 and making it ready for analysis in real time. The image from the image capturing module 102 is first sent to the cropping module 106. The cropping module 106 locates the one or more objects within the image and crops them from the image. The cut-out portions of the image are called one or more cropped images.

According to a preferred embodiment of the present invention, the one or more cropped images are filtered based on a pre-defined criteria, i.e., only those objects that are facing towards the image capturing module 102 are selected for further processing. The one or more objects facing towards the image capturing module 102 are scrutinized for their content and then selected by the filtering module 108. The one or more objects selected at this step are referred to as one or more filtered images. The one or more filtered images are used by the image classifier 110. According to a preferred embodiment of the present invention, the image classifier 110 uses neural network based approaches to determine content of the one or more filtered images.

The natural language of road/traffic signs are detected by the image classifier 110 of the processing module 104. Various CNN based methods can be employed for determining the traffic information/signage encountered. Convolutional neural network based approaches that are used exclusively for traffic/driving based inferences can be used by the image classifier 102, for example, Capsule Neural Network (CapsNet), Traffic Sign Yolo (TS-Yolo), Convolutional Neural Network (CNN) etc.

These approaches identify the text and assign traffic information related information to the one or more filtered images. The traffic information can be segregated based on the information type, like mandatory, prohibitory, danger etc. The one or more filtered images are further classified based on the specific type of traffic signage included therein. For example a traffic “safety sign” is in fact a “speed limit” sign and specifically prohibiting speed exceeding 60 mph on given location of the vehicle. According to the preferred embodiment of the present invention, the exact classification is associated by the image classifier 110 on the one or more filtered images.

The image reducer 112 of the processing module 104 takes input directly from the image capturing module 102. The image from the image capturing module 102 is resized, so that memory and computing resources are quick and efficient in analyzing the data within the image. The quick yet precise analysis is essential for ADAS as well as overall vehicle safety. According to a preferred embodiment, the image is resized by the image reducer 112 to reduce the pixel and overall size of the image. The less the resolution, the quicker and easier it is for the processing module 104 to provide assistance as per system 100. The image that is lower in resolution is called a resized image.

The resized image from the image reducer 112 and the one or more filtered images from the image classifier 110 are used by the traffic analysis module. According to one exemplary embodiment of the present invention, the resized image is a 720p image (about 44% ((720*1280)/(1080*1920)) compared with the image originally generated by the image capturing device 102. The resized image occupies lesser space and resources within the system 100.

According to a preferred embodiment of the present invention, the traffic analysis module 114 pin-points the location of the one or more filtered images from the filtering module 108 by overlaying onto the resized images the one or more filtered images that were classified by the filtering module 108. These resized images with recognized classifiers and the one or more objects are mapped on the image originally created to map-out the one or more objects in real time and provide assistance accordingly.

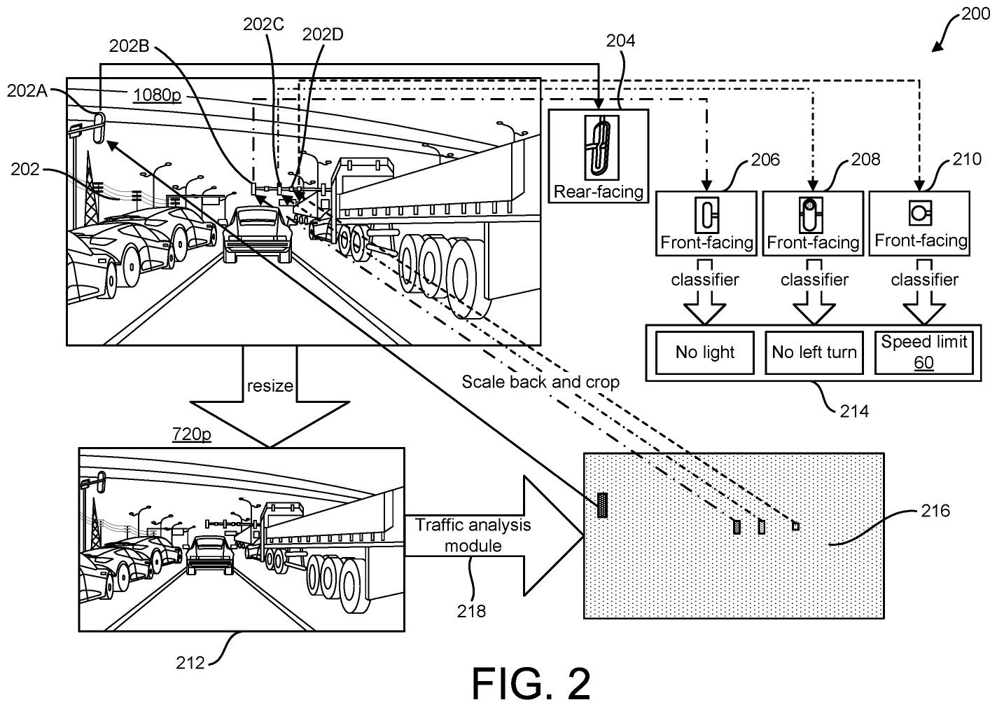

FIG. 2 is an exemplary view of the assistance provided by the system of the present invention using an image 202. The image 202 is generated by an image capturing module present within the vehicle and captures the traffic and road view for analysis in real-time. The image 202 shown in FIG. 2, includes a view of one or more objects of interest, e.g., traffic signs with other components of view of road, i.e., many cars and trucks. The traffic signs in the image 202 are of two types: traffic lights 202A, 202B, 202C and traffic sign 202D.

According to a preferred embodiment of the present invention, the image 202 generated by the image capturing module is in high resolution. The cropping module of the processing module takes the image 202, and crops out the traffic lights, i.e., the one or more objects 202A, 202B, 202C, 202D from the image 202. Performing cropping function on the image 202 ensures that the one or more objects 202A, 202B, 202C, 202D produce clear and defined one or more cropped images 204, 206, 208, 210.

According to a preferred embodiment of the present invention, the one or more cropped images 204, 206, 208, 210 are filtered based on orientation of the one or more objects 202A, 202B, 202C, 202D. In FIG. 2, the one or more cropped images are of a rear facing traffic light 204, a first front facing traffic light 206, a second front facing traffic light 208, and a front facing speed sign 210. The filtering module of the present invention excludes the rear facing traffic light 204 and includes the first front facing traffic lights 206, the second front facing traffic light 208, and the front facing speed sign 210 as one or more filtered images. According to a preferred embodiment of the present invention, further clarity of the one or more filtered images 214 is provided by an image classifier present within the processing module of the present invention. According to a preferred embodiment of the present invention, the one or more filtered images 214 are classified based on traffic classification codes.

The recognition of natural language text on the one or more filtered images 214 is done using neural network based approaches. The image classifier includes CNN based models that assign context to the detected text on the traffic sign/light. According to exemplary embodiment as shown in FIG. 2, the one or more cropped images 206, 208, 210 are classified further by the image classifier. The first front facing traffic light 206 having “no light.” the second front facing light 208 having “red light” with no left turn allowed, and the front speed sign 210 having speed limit of 60 mph on current road, respectively. The inferences and classifiers are used by a traffic analysis module 218 for providing assistance in real time. According to a preferred embodiment of the present invention, the traffic analysis module 218 uses the one or more filtered images 214 and resized version of the image 202 provided by an image reducer.

The image reducer reduces the resolution of the image 202 originally created into image of lesser resolution called a resized image 212. In the exemplary embodiment of FIG. 2, the image 202 is of higher quality, i.e., 1080p or 8M, which is resized and reduced to the resized image 212 of 720p for processing by the traffic analysis module 218. The resized image 212 is better for quick and efficient analysis of the image 202, as lesser computing resources are allocated by the traffic analysis module 218 for analysis further. The traffic analysis module locates object locations of the one or more objects 202A, 202B, 202C, 202D on the resized image 212. The traffic analysis module then maps 216 the object locations of the one or more objects 202A, 202B, 202C, 202D to a map 216. The map 216 is then scaled back to the image 202, in order to provide real-time assistance to a vehicle with the system of the present invention.

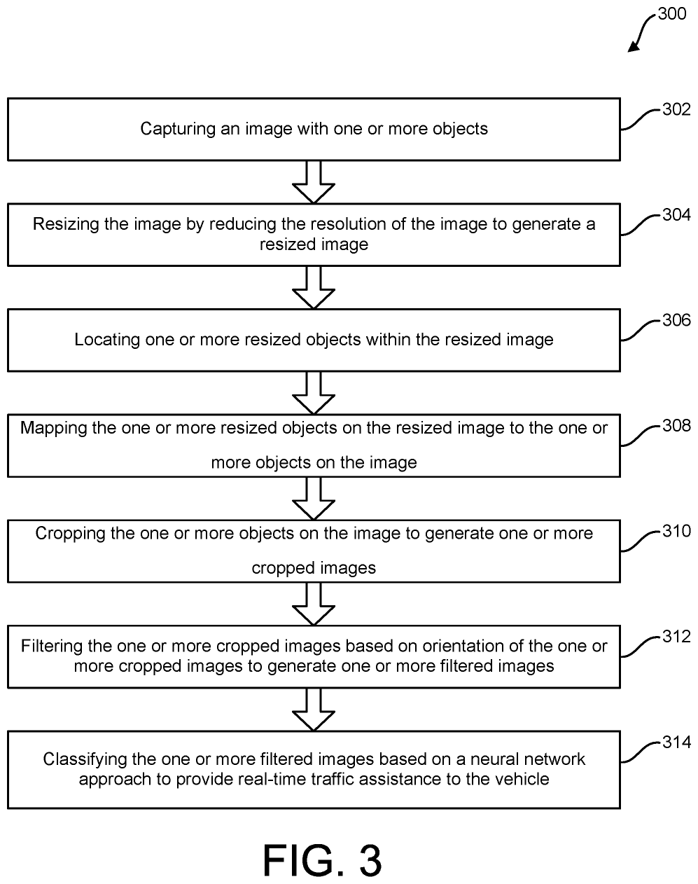

FIG. 3 outlines a method of providing real-time traffic assistance to a vehicle with image processing capabilities in accordance with the present invention. The vehicle can be self-driven or include ADAS. The method includes the steps of: capturing an original image with one or more objects; resizing the image to generate a resized image; locating the objects (e.g., traffic lights) in the resized image; mapping the locations of the objects of the resized image to the original image; cropping the objects out from the original image to generate cropped images; filtering the cropped images based on the orientation of the cropped images to generate filtered images; and classifying the filtered images based on a neural network approach to provide real-time traffic assistance to the vehicle. The advantage of this method is that the original image (high resolution) is not processed at the beginning, but the resized image (low resolution) is processed to find the locations of objects (e.g., traffic light). Then, the locations of the objects are mapped to the original image, cropping the object out of the original image and recognize the information conveyed by the object.

The method according to FIG. 3 commences with step 302 by capturing an image of real time traffic. The image captured includes one or more objects, wherein the one or more objects are traffic signs or lights present at the time of capturing the image. Step 304 is resizing the image by reducing the resolution of the image to generate a resized image. The resizing is accomplished by simply reducing the pixels of the image to generate the resized image. The image size at step 302 is higher compared to a resized image generated at step 304. The use of resized image at step 304 ensures fast and precise traffic assistance. Next, step 306 is locating one or more resized objects within the resized image. Step 308 involves mapping the one more resized objects on the resized image to the one or more objects on the image. The resized images with the one or more filtered images is compared with the image of high resolution to provide inference of the one or more objects detected in real time by the vehicle and the driver using the system.

Next, step 310, is cropping the one or more objects on the image to generate one or more cropped images. The one or more cropped images are clear and do not require further processing before classification, as the image generated by the image capturing module is sufficiently high in resolution to avoid blurring or wrongful detection by the system of the present invention. Furthermore, the addition step of detecting the orientation of the one or more resized objects and assigning the orientation of the one or more resized objects to the one or more cropped images may be performed.

Next, step 312 is filtering the one or more cropped images based on the orientation of the one or more cropped images to generate one or more filtered images. Here, the filtering filters out any one of the one or more cropped images that shows the traffic light or sign facing away from the vehicle's point-of view or away from the image capturing module of the real time traffic assistance system.

Finally, step 314 involves classifying the one or more filtered images based on a neural network approach to provide real-time traffic assistance to the vehicle. The neural network can be used for image and natural language inference for traffic sign/light detection. A CNN can be used for associating context and meaning to the one or more filtered images and classified accordingly.

I claim:

1. A real-time vehicle traffic assistance system, comprising:
an image capturing module for capturing an image with one or more objects therein;
a processing module comprising:
a cropping module for cropping the one or more objects in the image to generate one or more cropped images;
a filtering module for filtering the one or more cropped images based on the orientation of the one or more cropped images to generate one or more filtered images;
an image classifier for classifying the one or more filtered images based on a neural network approach; and
an image reducer for reducing resolution of the image to generate a resized image; and
a traffic analysis module, wherein the traffic analysis module locates object locations of the one or more objects on the resized image, maps the object locations of the one or more objects to a map, and then scales back the map to the image to provide real-time traffic assistance to a vehicle.

2. The system of claim 1, wherein the vehicle is either a manually driven vehicle or a self-driven vehicle.

3. The system of claim 1, wherein the image capturing module is a camera mounted onboard the vehicle.

4. The system of claim 3, wherein the camera captures images of either a road, a driveway, a traffic, or a runway.

5. The system of claim 1, wherein the one or more objects are traffic signal lights, traffic road signs, road safety information, runway safety information, driveway regulatory signs, or runway regulatory signs.

6. The system of claim 1, wherein the image classifier is a classification code related to the type of traffic information displayed by the one or more objects in real time.

7. The system of claim 6, wherein the traffic information includes green light, speed limits, school proximity, landslide hazards, or turns.

8. The system of claim 1, wherein the neural network approach can be selected from either of Capsule Neural Network, Traffic Sign Yolo, or Convolutional Neural Network.

9. The system of claim 1, wherein the traffic analysis module compares the one or more filtered images on the image and locates the one or more filtered images on the resized image before mapping.

10. The system of claim 1, wherein the traffic analysis module uses mapping of the one or more cropped images to detect traffic information on a road in real time.

11. The system of claim 10, wherein the one or more cropped images are associated with the classification code.

12. A method for providing real-time vehicle traffic assistance, comprising:
capturing an image with one or more objects;
resizing the image by reducing the resolution of the image to generate a resized image;
locating one or more resized objects within the resized image;
mapping the one or more resized objects of the resized image to the one or more objects of the image;
cropping the one or more objects of the image to generate one or more cropped images;
filtering the one or more cropped images based on the orientation of the one or more cropped images to generate one or more filtered images; and
classifying the one or more filtered images based on a neural network approach to provide real-time traffic assistance to a vehicle.

13. The method of claim 12, further comprising:
detecting the orientation of the one or more resized objects; and
assigning the orientation of the one or more resized objects to the one or more cropped images.
